(19) United States
(12) Patent Application Publication
(10) Pub. No.: US 2024/0147229 A1
(43) Pub. Date: May 2, 2024

(54) ONBOARDING USING LI-FI FOR DPP BOOTSTRAPPING

(71) Applicant: ARRIS Enterprises LLC, Suwanee, GA (US)

(72) Inventors: Aniket SALUNKHE, Thane (IN); Jawad FAKHROO, Honavar (IN)

(21) Appl. No.: 18/386,005

(22) Filed: Nov. 1, 2023

Related U.S. Application Data
(60) Provisional application No. 63/421,650, filed on Nov. 2, 2022.

(51) Int. Cl. H04W 12/0431; H04W 12/48

(52) U.S. Cl. CPC H04W 12/0431; H04W 12/48

(57) ABSTRACT

Easy Connect is a simple and fast onboarding method that avoids the inconvenience caused by other existing onboarding methods. However, onboarding of enrollee devices can be problematic given the requirement of user interaction. Improvements are made to the onboarding process of enrollee devices within proximity of a configurator device by utilizing Li-Fi for those enrollee devices that are Li-Fi capable. The initial bootstrapping information can be made using Li-Fi as out-of-band (OOB) for transmission between the configurator device and the one or more enrollee devices. Once the enrollee device receives the bootstrapping information via Li-Fi, the enrollee device and the configurator device can continue onboarding using a wireless connection without requiring user intervention.

### BACKGROUND

Increasingly, more and more network environments include multiple network devices. Many network devices require extensive onboarding to access the network. Thus, there is a need to quickly and efficiently onboard network devices in a network environment.

### SUMMARY

An aspect of the present disclosure is drawn to a network device for initiating an onboarding process over Light Fidelity (Li-Fi). The network device comprises a memory storing one or more computer-readable instructions, and a processor coupled to the memory. The processor is configured to execute the one or more computer-readable instructions to cause the network device to generate a bootstrapping information, wherein the bootstrapping information comprises a device provisioning protocol (DPP) bootstrapping information associated with the network device, and send the bootstrapping information to another network device over Li-Fi as out-of-band (OOB) for initiating an onboarding process.

In an aspect of the present disclosure, the DPP bootstrapping information comprises any of a bootstrapping public key, a channel indicator, and a channel list associated with the network device, or any combination thereof.

In an aspect of the present disclosure, the bootstrapping public key is embedded within a bootstrapping uniform resource indicator.

In an aspect of the present disclosure, the network device is a configurator device that enters a responder state and the another network device is an enrollee device that enters an initiator state, and wherein the bootstrapping public key is associated with the configurator device.

In an aspect of the present disclosure, the processor is further configured to execute the one or more computer-readable instructions to further cause the network device to receive an enrollee request for DPP authentication from the enrollee device, send a configurator response for DPP authentication to the enrollee device, receive an enrollee request for provisioning from the enrollee device, send a configurator response for provisioning to the enrollee device, send one or more communications to the enrollee device via wireless fidelity (Wi-Fi).

In an aspect of the present disclosure, the network device is a configurator device that enters an initiator state and the another network device is an enrollee device that enters a responder state, and wherein the bootstrapping public key is associated with the enrollee device.

In an aspect of the present disclosure, the processor is further configured to execute the one or more computer-readable instructions to further cause the network device to send a configuration instruction for DPP authentication to the enrollee device, receive an enrollee response for DPP authentication from the enrollee device, receive an enrollee request for provisioning from the enrollee device, send a configurator response for provisioning to the enrollee device, and send one or more communications to the enrollee device via wireless fidelity (Wi-Fi).

An aspect of the present disclosure is drawn to a method for initiating an onboarding process over Light Fidelity (Li-Fi) by a network device. The method comprises for initiating an onboarding process over Light Fidelity (Li-Fi) by a network device, and sending the bootstrapping information to another network device over Li-Fi as out-of-band (OOB) for initiating an onboarding process.

In an aspect of the present disclosure, the method is such that the DPP bootstrapping information comprises any of a bootstrapping public key, a channel indicator, and a channel list associated with the network device, or any combination thereof.

In an aspect of the present disclosure, the method is such that the bootstrapping public key is embed within a bootstrapping uniform resource indicator.

In an aspect of the present disclosure, the method is such that the network device is a configurator device that enters a responder state and the another network device is an enrollee device that enters an initiator state, and wherein the bootstrapping public key is associated with the configurator device.

In an aspect of the present disclosure, the method further comprises receiving an enrollee request for DPP authentication from the enrollee device, sending a configurator response for DPP authentication to the enrollee device, receiving an enrollee request for provisioning from the enrollee device, sending a configurator response for provisioning to the enrollee device, sending one or more communications to the enrollee device via wireless fidelity (Wi-Fi).

In an aspect of the present disclosure, the method is such that the network device is configurator device that enters an initiator state and the another network device is an enrollee device that enters a responder state, and wherein the bootstrapping public key is associated with the enrollee device.

In an aspect of the present disclosure, the method further comprises send a configuration instruction for DPP authentication to the enrollee device, receive an enrollee response for DPP authentication from the enrollee device, receiving an enrollee request for provisioning from the enrollee device, sending a configurator response for provisioning to the enrollee device, sending one or more communications to the enrollee device via wireless fidelity (Wi-Fi).

An aspect of the present disclosure provides a computer readable medium of a network device having one or more computer-readable instructions stored thereon. The one or more computer-readable instructions when executed by a processor of the network device, cause the network device to perform one or more operations including the steps of the methods described herein.

### BRIEF DESCRIPTION OF THE DRAWINGS

FIG. 1 is a diagram of a network environment for onboarding network devices, according to one or more aspects of the present disclosure;

FIG. 2 is a block diagram of a hardware configuration for one or more network devices, according to one or more aspects of the present disclosure;

FIG. 3 is a block diagram illustrating onboarding a network device using Li-Fi, according to one or more aspects of the present disclosure;

FIG. 4 is a flowchart for a configurator device to onboard an enrollee device, according to one or more aspects of the present disclosure;

FIG. 5 is a flowchart for a configurator device to onboard an enrollee device, according to one or more aspects of the present disclosure;

FIG. 6 is a diagram of a message flow for a configurator device acting as an initiator to onboard an enrollee device acting as a responder, according to one or more aspects of the present disclosure; and

FIG. 7 is a flowchart for a network device for onboarding another network device using Li-Fi.

Like reference numbers and designations in the various drawings indicate like elements.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded as merely examples and not for the purpose of limiting the present disclosure as defined by the appended claims and their equivalents. The words and phrases used in the following description and claims are merely used to enable a clear and consistent understanding of the present disclosure. In addition, descriptions of well-known structures, functions, and configurations may be omitted for clarity and conciseness. Those of ordinary skill in the art will recognize that various changes and modifications of the examples described herein can be made without departing from the spirit and scope of the present disclosure.

One or more novel aspects of the present disclosure provide for onboarding (for example, activating and/or configuring) one or more network devices to seamlessly establish a wireless network using Light Fidelity (Li-Fi), for example, in Wi-Fi Certified Easy Connect™. Li-Fi (also referred to as LiFi) is a wireless technology that utilizes visible light as a communication medium. Li-Fi can be used for the enrollment of network devices. For example, enrollment of network devices can be performed using public key identity where the identity of the network device enrollment is conveyed via an out-of-band (OOB) mechanism. According to one or more aspects of the present disclosure, the bootstrapping information is generated and sent over Li-Fi as OOB, for example, for Wi-Fi Certified Easy Connect™.

Device provisioning protocol (DPP), which is also known as Wi-Fi Certified Easy Connect™ or Easy Connect, is a provisioning protocol certified by the Wi-Fi alliance. The Wi-Fi Alliance has developed this protocol as a solution to ensure the simple, secure addition of any Wi-Fi device, including those with little or no user interface, to a wireless network. Wi-Fi Certified Easy Connect™ reduces the complexity of onboarding Wi-Fi devices while still maintaining high security standards. DPP is a secure and standardized provisioning protocol for configuration of Wi-Fi devices. DPP is to replace the Wi-Fi Protected Setup (WPS) protocol that has security weaknesses. Unlike older protocols (such as WPS), DPP incorporates strong encryption through public key cryptography so that networks remain secure as new network devices are added. DPP protects against threats such as eavesdropping, active attacks to add unauthorized network devices to existing networks, and denial of service blocking provisioning.

Easy Connect is a simple and fast onboarding method that avoids the inconvenience caused by other existing onboarding methods. With the proliferation of Internet of Things (IoT) Wi-Fi network devices that have no easy way to connect to a Wi-Fi network, DPP can be used to provision through another network device, such as a mobile phone. If an IoT device doesn't have a user interface another network device, can use various methods such as NFC, Bluetooth, password, and quick response (QR) code, to provide secure connection to the IoT device. This reduces complexity and improves user experience when onboarding network devices without a user interface, such as smart home devices, IoT devices, any other Wi-Fi network device without a user interface, etc.

According to one or more novel solutions of the present disclosure, adding a new network device to a Wi-Fi network with Easy Connect, also referred to as onboarding a network device, can be performed by scanning a QR code. A user can select a network device as the centerpiece or main network device of a configuration for a Wi-Fi network. This main network device is generally one with a rich user interface, such as a smart phone or a tablet, but can be any network device configured to, or otherwise capable, any of scan a QR code, a near field communication (NFC) tag, run protocol developed by the Wi-Fi Alliance, and/or download information from a network resource associated with the main network device, or any combination thereof. This main network device can be considered the configurator device and all other network devices can be considered enrollee devices. A user establishes a secure connection with an enrollee device by any of scanning any of a device specific QR code, a device specific NFC tag, or both, downloading device specific information from a network resource associated with the network device, or any combination thereof. This prompts the protocol to run and automatically provision the enrollee device with one or more credentials needed to access the Wi-Fi network.

Li-Fi is a bi-directional wireless communication technology which utilizes light to transmit data and position between network devices. Li-Fi is a light communication system that is capable of transmitting data at high speeds over visible light, ultraviolet, and infrared spectrums. Li-Fi technology requires two components: a photodiode and a light source. The photodiode acts as a transceiver that receives light signals and transmits them back. The light source transmits data using emitted light as the medium. The light source can be an LED light bulb that emits pulses of light that are undetectable to the human eye. Within the emitted pulses can be data that travels to and from one or more receivers. At an opposite end from the light source, a photosensitive detector demodulates the light frequency signal and converts it back into an electronic data stream.

According to one or more novel solutions of the present disclosure, Easy Connect uses a mechanism of OOB communication channel to minimize the user interaction. A network status query is triggered for headless network devices without or with little user interaction. For example, most network devices have a light source, for example, a flashlight or photodiode in a smart phone, a light emitted diode (LED) in IoT devices, etc. An enhancement to DPP uses Li-Fi as an OOB communication channel. Such novel solutions as discussed in the present disclosure provide for zero-touch onboarding and bulk provisioning which increases the efficiency of onboarding client devices as well as conserves valuable resources.

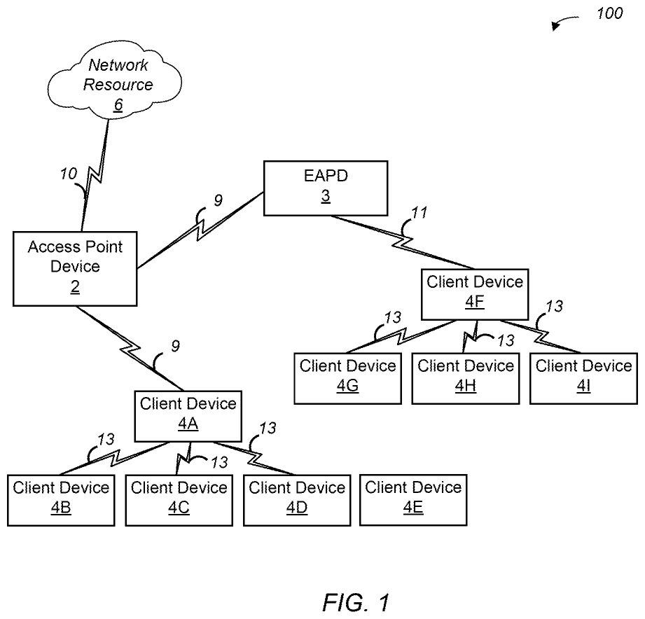

FIG. 1 is a diagram of a network environment 100, according to one or more aspects of the present disclosure. It should be appreciated that various example embodiments of inventive concepts disclosed herein are not limited to specific numbers or combinations of electronic devices, and there may be one or multiple of some of the aforementioned electronic devices, such as one or more network devices, in a network environment, which may itself consist of multiple communication networks and various known or future developed wireless connectivity technologies, protocols, devices, and the like.

The network environment 100 comprises one or more network devices connected to a network resource 6. For example, the one or more network devices can comprise an access point device 2, an extender access point device 3, one or more client device 4 (such as client devices 4A-4I, collectively referred to as client device(s) 4). The one or more network devices can be connected to a network resource 6, and also connected to one or more other electronic devices such as an access point device 2, an extender access point devices 3 and a client device 4. The network environment 100 includes wired and/or wireless network devices that may be connected in one or more wireless networks (for example, private, guest, iControl, backhaul network, or Internet of things (IoT) network) within the network environment 100. Additionally, there could be some overlap between network devices in the different networks. That is, one or more network devices could be located in more than one network. For example, the extender access point device 3 could be located both in a private network for providing content and information to a client device 4 and also included in a backhaul network or an iControl network.

A network resource 6 can be a cloud-based service that provides access to a cloud-based repository and/or service. In one or more embodiments, network resource 6 may be accessible via a cellular communications service provider. The connection 10 between the network resource 6 and the access point device 2 can be implemented using a wide area network (WAN), a virtual private network (VPN), metropolitan area networks (MANs), system area networks (SANs), a data over cable service interface specification (DOCSIS) network, a fiber optics network (e.g., FTTH (fiber to the home) or FTTX (fiber to the x), or hybrid fiber-coaxial (HFC)), a digital subscriber line (DSL), a public switched data network (PSDN), a global Telex network, or a 2G, 3G, 4G, 5G, or 6G network, for example.

The connection 10 between the network resource 6 and the access point device 2 can be implemented using a wide area network (WAN), a virtual private network (VPN), metropolitan area networks (MANs), system area networks (SANs), a data over cable service interface specification (DOCSIS) network, a fiber optics network (e.g., FTTH (fiber to the home) or FTTX (fiber to the x), or hybrid fiber-coaxial (HFC)), a digital subscriber line (DSL), a public switched data network (PSDN), a global Telex network, or a 2G, 3G, 4G, 5G, or 6G network, for example. The connection 10 can further include as some portion thereof a broadband mobile phone network connection, an optical network connection, or other similar connections. For example, the connection 10 can also be implemented using a fixed wireless connection that operates in accordance with, but is not limited to, 3rd Generation Partnership Project (3GPP) Long Term Evolution (LTE), 5G, or 6G protocols. It is also contemplated by the present disclosure that connection 13 is capable of providing connections between the access point device 2 and a WAN, a LAN, a VPN, MANs, PANs, WLANs, SANs, a DOCSIS network, a fiber optics network (e.g., FTTH, FTTX, or HFC), a PSDN, a global Telex network, or a 2G, 3G, 4G, 5G or 6G network, for example.

The access point device (APD) 2 can be, for example, an access point and/or a hardware electronic device that may be a combination modem and gateway that combines the functions of a modem, an access point (AP), and/or a router for receiving/sending information to/from a network resource 6 in the network environment 100. In one or more embodiments. The present disclosure all contemplates that the access point device 2 can include the function of, but is not limited to, a universal plug and play (UPnP) simple network management protocol (SNMP), an Internet Protocol/Quadrature Amplitude Modulator (IP/QAM) set-top box (STB) or smart media device (SMD) that is capable of decoding audio/video content, and playing over-the-top (OTT) or multiple system operator (MSO) provided content. The access point device 2 may also be referred to as a residential gateway, a home network gateway, or a wireless access point (AP).

The connection 9 between an access point device 2, a wireless extender access point device (EAPD) 3, and one or more client devices 4 can be implemented using a wireless connection in accordance with any IEEE 802.11 Wi-Fi protocols, Bluetooth protocols, BLE, Li-Fi protocols, or other short range protocols that operate in accordance with a wireless technology standard for exchanging data over short distances using any licensed or unlicensed band such as the citizens broadband radio service (CBRS) band, 2.4 GHz bands, 5 GHz bands, 6 GHz bands, or 60 GHz bands. Additionally, the connection 9 can be implemented using a wireless connection that operates in accordance with, but is not limited to, RF4CE protocol, ZigBee protocol, Z-Wave protocol, or IEEE 802.15.4 protocol. It is also contemplated by the present disclosure that the connection 9 can include connections to a media over coax (MoCA) network. One or more of the connections 9 can also be a wired Ethernet connection. Any one or more of connections 9 can carry information on any of one or more channels that are available for use.

The extender access point device (EAPD) 3 can be, for example, wireless hardware electronic devices such as access points, extenders, repeaters, etc. used to extend the wireless network by receiving the signals transmitted by the access point device 2 and rebroadcasting the signals to, for example, one or more client devices 4. The extender access point device 3 can also receive signals from the client devices 4 and rebroadcast the signals to the access point device 2, or one or more other client devices 4.

The connection 11 between the extender access point device 3 and the one or more client devices 4 are implemented through a wireless connection that operates in accordance with any IEEE 802.11 Wi-Fi protocols, Bluetooth protocols, Bluetooth low energy (BLE), Li-Fi protocols, or other short range protocols that operate in accordance with a wireless technology standard for exchanging data over short distances using any licensed or unlicensed band such as the CBRS band, 2.4 GHz bands, 5 GHz bands, 6 GHz bands or 60 GHz bands. Additionally, the connection 11 can be implemented using a wireless connection that operates in accordance with, but is not limited to, RF4CE protocol, ZigBee protocol, Z-Wave protocol, or IEEE 802.15.4 protocol. Also, one or more of the connections 11 can be a wired Ethernet connection. Any one or more connections 11 can carry information on any one or more channels that are available for use.

The one or more client devices 4 can be, for example, hand-held computing devices, personal computers, electronic tablets, mobile phones, smart phones, smart speakers, Internet-of-Things (IoT) devices, iControl devices, portable music players with smart capabilities capable of connecting to the Internet, cellular networks, and interconnecting with other devices via Wi-Fi, Li-Fi, and/or Bluetooth, or other wireless hand-held consumer electronic devices capable of accessing a wireless network. For example, any one or more client devices 4 can be a mobile electronic device capable of connecting to a wireless network and provisioning the access point device 2 to provide a 6 GHz wireless frequency band network. Additionally, any one or more client devices 4 can be a television (TV), an IP/QAM set-top box (STB) or a streaming media decoder that is capable of decoding audio/video content, and playing over OTT or MSO provided content received through the access point device 2.

In one or more embodiments, client device 4A, client device 4F, or both can be a configurator device for use in onboarding one or more other network devices, such as any of client device 4B, client device 4C, client device 4D, client device 4E and/or client device 4G, client device 4H, and/or client device 4I, respectively. For example, client device 4A and/or client device 4F can communicate over Li-Fi (connections, 9 and/or 11, respectively) to establish a network with the access point device 2 and can communication over connections 13 to onboard or otherwise provision one or more other network devices, such as client devices 4B-4E and/or 4G-4I, respectively.

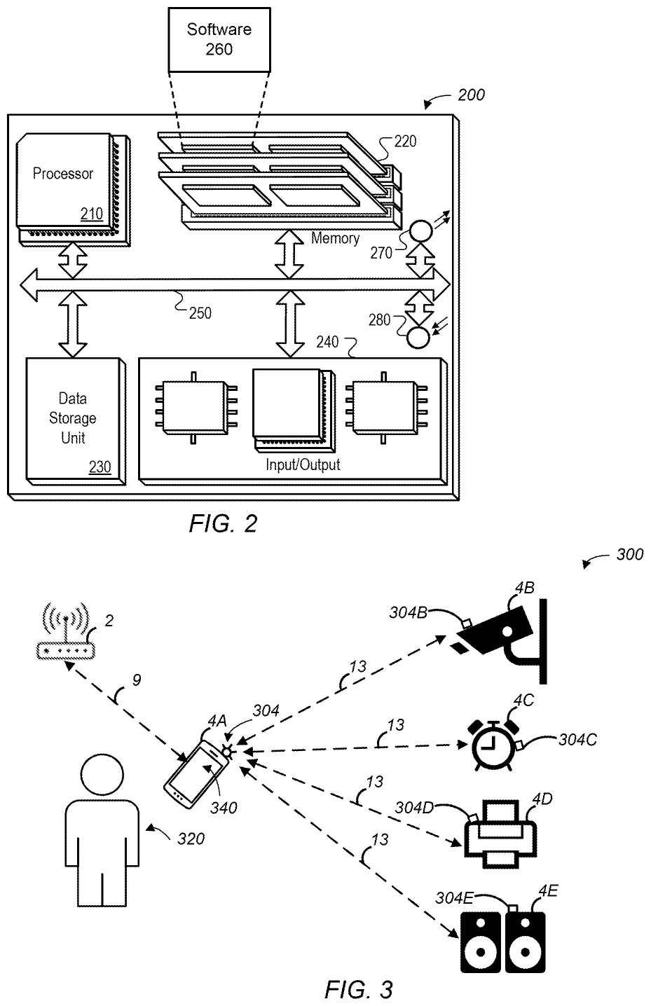

A detailed description of the exemplary internal components of the access point device 2, the extender access point device 3, and the one or more client devices 4 shown in FIG. 1 will be provided in the discussion of FIG. 2. However, in general, it is contemplated by the present disclosure that the access point device 2, the extender access point device 3, and the one or more client devices 4 include electronic components or electronic computing devices (such as one or more elements 135) operable to receive, transmit, process, store, and/or manage data and information associated with the network environment 100, which encompasses any suitable processing device adapted to perform computing tasks consistent with the execution of computer-readable instructions stored in a memory or a computer-readable recording medium (for example, a non-transitory computer-readable medium).

Further, any, all, or some of the computing components in the access point device 2, the extender access point device 3, and the one or more client devices 4 may be adapted to execute any operating system, including Linux, UNIX, Windows, MacOS, DOS, and Chrome OS as well as virtual machines adapted to virtualize execution of a particular operating system, including customized and proprietary operating systems. The access point device 2, the extender access point device 3, and the one or more client devices 4 are further equipped with components to facilitate communication with other computing devices or network devices over the one or more network connections to local and wide area networks, wireless and wired networks, public and private networks, and any other communication network enabling communication in the network environment 100.

FIG. 2 is a block diagram of a network device 200 for one or more network devices, for example, within a network environment 100. The network device 200 can comprise a processor 210, a memory 220, a storage device or data storage unit 230, an input/output (I/O) device 240, a light source or transmitter 270, and a light receiver 280. Each of the components 210, 220, 230, 240, 270 and 280 can, for example, be interconnected using a system bus 250. The processor 210 can be capable of processing one or more computer-readable instructions for execution within the network device 200. In one or more embodiments, the processor 210 can be a single-threaded processor. In one or more embodiments, the processor 210 can be a multi-threaded processor. The processor 210 can be capable of processing one or more computer-readable instructions stored in the memory 220 and/or on the data storage unit or storage device 230.

The memory 220 can store information within the network device 200. In one implementation, the memory 220 can be a non-transitory computer-readable medium that stores one or more computer-readable instructions that when executed by a processor 210 cause the electronic device to perform one or more operations according to one or more aspects of the present disclosure. In one implementation, the memory 220 can be a volatile memory unit. In another implementation, the memory 220 can be a non-volatile memory unit. In one or more embodiments, the storage device 230 can be capable of providing mass storage for the network device 200. In one implementation, the data storage unit 230 can be a non-transitory computer-readable medium. In various different implementations, the data storage unit 230 can, for example, include a hard disk device, an optical disk device, flash memory or some other large capacity storage device. In other implementations, the data storage unit 230 can be a device external to the network device 200. The memory 220 can store a software 260. Software 260 can comprise one or more computer-readable instructions that when executed by the processor 210 cause the electronic device to provide onboarding of a network device using Li-Fi.

The input/output (I/O) device 240 provides I/O operations for the network device 200. In one implementation, the I/O device 240 can include one or more of a network interface device (for example, an Ethernet card), a serial communication device (for example, an RS-232 port), one or more universal serial bus (USB) interfaces (for example, a USB 2.0 port), one or more wireless interface devices (for example, an 802.11 card), or any combination thereof. As an example, the I/O device 240 can include one or more driver devices configured to send communications to, and receive communications from one or more networks and/or one or more other network devices. In one or more embodiments, I/O 240 provides a user interface, such as a graphical user interface, for displaying information and/or receiving a user input.

A light source or transmitter 270 can be any light source for transmitting light for use with transmitting data via Li-Fi, for example, for onboarding a network device. A light receiver 280 can be any receiver for receiving light for use with receiving data via Li-Fi, for example, for onboarding a network device. The light source 270 and the light receiver 280 can be a single component or distinct components.

FIG. 3 is a block diagram illustrating onboarding a network device using Li-Fi, according to one or more aspects of the present disclosure. A network device, such as any of an access point 2, an extender access point device 3, a client device 4, or any combination thereof, can be part of a network environment 300. A user 320 can be associated with a client device 4A, for example, a smart phone. The user 320 can initiate onboarding of one or more other network devices, for example, one or more other client devices 4B-4E, for example, a camera, a clock, a printer, and a speaker, respectively, so that any of the network devices can access the Wi-Fi network of network environment 300.

Client device 4A can be a Li-Fi enabled network device that comprises a user interface 340. Client device 4A can be selected to be a central point of configuration for onboarding other network devices and designated as a configurator device 4A. The configurator device 4A establishes a Wi-Fi connection 9 with an access point device 2 over Li-Fi. The client device 4A as the configurator device 4A enables an enrollee device, such as any one or more of client devices 4B-4E, to discover, select, and/or connect with zero touch to the wireless network.

As an example, to setup a network environment 300 that allows for Wi-Fi network access by one or more network devices, a configurator device 4A runs DPP using one or more Li-Fi components, to provision an initial enrollee access point device 2 to establish a Wi-Fi network. Once the Wi-Fi network is established, one or more network devices, for example, any one or more client devices 4B-4E, as one or more enrollee clients can be onboarded using Li-Fi. While FIG. 3 illustrates a client device 4A communicating bootstrap information over Li-Fi as an OOB to an access point device 2, the present disclosure contemplates that any one or more client devices 4 can be utilized to communicate bootstrap information over Li-Fi as an OOB to any of one or more other access point devices 2, one or more extender access point devices 3, or any combination thereof.

An enrollee client obtains an enrollee client specific configuration that enables the enrollee client to join a target network, for example, the Wi-Fi network. The configuration process produces one or more security credentials unique to the enrollee client resulting in a mutually trusted connection to the target network. Once an enrollee device (for example, one or more client devices 4) has been enrolled and/or configured, then the enrollee device uses target network information provided by the configurator device 4A to discover, select and/or connect to the target network with requiring intervention by user 320.

For example, the DPP protocol is an extensible protocol that enables onboarding and configuration of network devices, such as one or more headless devices as illustrated in FIG. 3. The DPP protocol involves a bootstrapping phase, an authentication phase, a provisioning phase and a network access phase. In the bootstrapping phase, the transfer of public key credentials are transferred between network devices, for example, a configurator device (such as client device 4A) and one or more enrollee devices (such as any of client devices 4B-4E). Every device capable of using DPP has an identity. This identity is contained in some OOB form, either printed or digitally available, in the form of public and private keys. The public key is shared and the private key is kept secret but is decodable when a secure connection occurs between two network devices. During the bootstrapping phase, the configurator device and the enrollee device establish a trust relationship that allows these network devices to authenticate and establish a secure connection. In the authentication phase, a pairwise master key (PMK) and pairwise master key secure association (PMKSA) are created. DPP authentication frames are exchanged between the network devices and the public key credentials from the bootstrapping phase are used. The enrollee device (the enrollee device requiring or requesting access to the network) is provisioned in the provisioning phase. In the network access phase, the network devices (the enrollee device and the configurator device) mutually derive a PMK and pairwise master key identifier (PMKID). The PMK and PMKID are used by the enrollee device to gain access to the network established by the access point device 2.

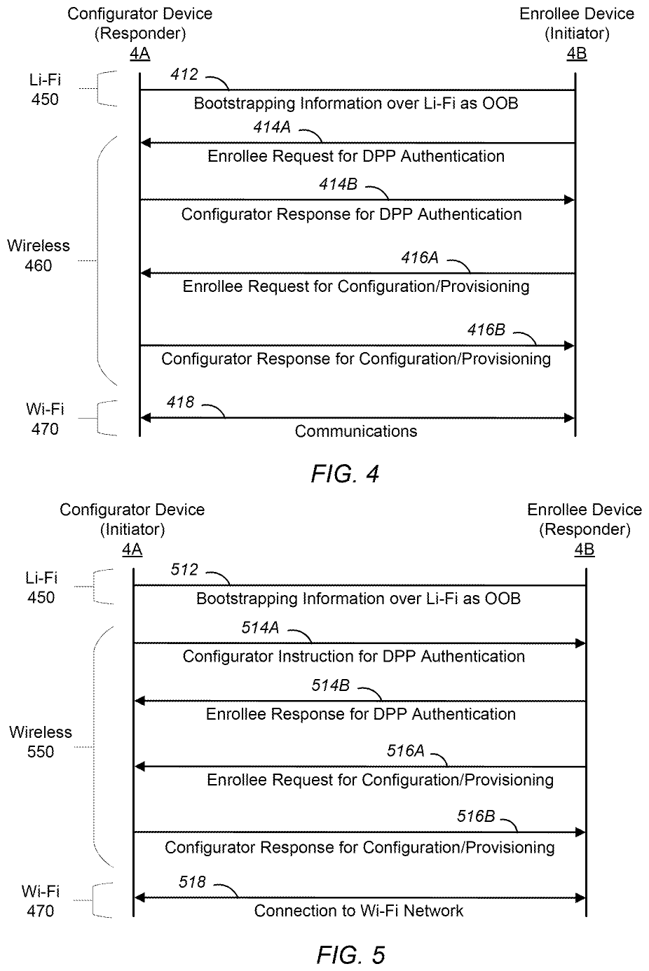

FIG. 4 is a flowchart for a configurator device (as responder) to onboard an enrollee device (as initiator), according to one or more aspects of the present disclosure. An enrollee device (for example a client device 4B) can be introduced in a network environment and initiate setup of the enrollee device 4B so as to provide access to a Wi-Fi network to the enrollee device 4B. The user can utilize a configurator device, for example, a client device 4A, to onboard the enrollee device 4B so that the enrollee device 4B can access a Wi-Fi network 470.

For example, the configurator device 4A can, that enters a responder state, initiate an onboarding process by sending a bootstrapping information 412 over Li-Fi 450 as OOB to the enrollee device 4B. The bootstrapping information 412 comprises DPP bootstrapping information, such as any of a bootstrapping public key associated with the configurator device 4A (for example, embedded within a bootstrapping uniform resource indicator (URI)), a global operating class channel, a channel list for DPP authentication (DPP AUTH), or any combination thereof. For example, a bootstrapping phase is entered such that one or more DPP bootstrapping Li-Fi packets are communicated between the configurator device 4A and the enrollee device 4B, including, but not limited to, the bootstrapping information 412 over Li-Fi as OOB.

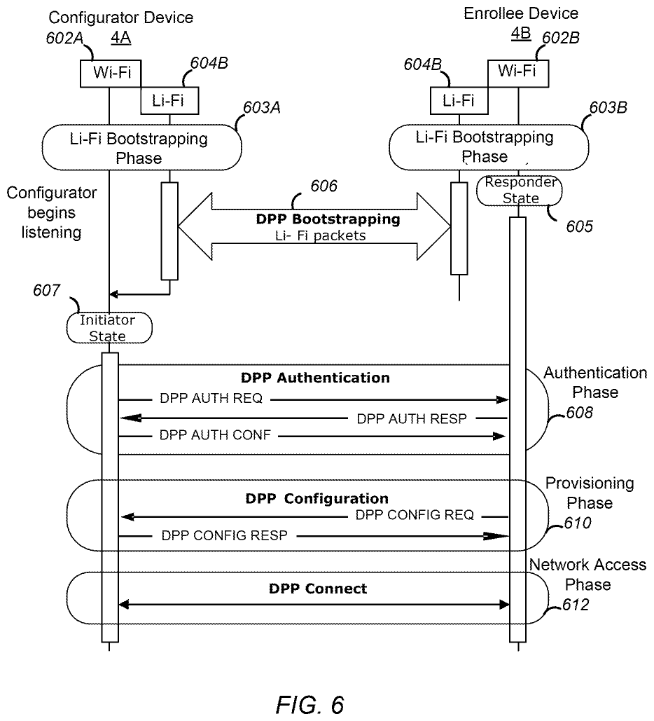

The enrollee device 4B enters an initiator state after a successful bootstrapping phase and can respond to the bootstrapping information 412 receiving during the bootstrapping phase by initiating the authentication phase, for example, by sending an enrollee request for DPP authentication 414A via a wireless network 460, such as by using Wi-Fi 470. The configurator device 4A can, in response to the enrollee request 414A, send a configurator response for DPP authentication 414B via the wireless network 460. DPP authentication is discussed with reference to the authentication phase 608 of FIG. 6.

The enrollee device 4B can initiate a provisioning phase after receiving the configuration response 414B by sending an enrollee request for provisioning (also referred to as configuring) 416A to the configurator device 4A via the wireless network 460. The configurator device 4A can, in response to the enrollee request 416A, send a configurator response for provisioning (also referred to as configuring) 416B via the wireless network 460.

After provisioning the enrollee device 4B, the enrollee device 4B can initiate a network access phase where the enrollee device 4B has full access to the Wi-Fi network 470 such that the enrollee device 4B and the configurator device 4A can exchange communications 418 via the Wi-Fi network 470.

FIG. 5 is a flowchart for a configurator device (as initiator) to onboard an enrollee device (as responder), according to one or more aspects of the present disclosure. FIG. 5 is similar to FIG. 4 except that the configurator device 4A is an initiator and enrollee device 4B is a responder. An enrollee device 4B can be introduced in a network environment and initiate setup of the enrollee device 4B so as to provide access to a Wi-Fi network to the enrollee device 4B. The user can utilize a configurator device 4A to onboard the enrollee device 4B so that the enrollee device 4B can access a Wi-Fi network 470.

For example, the enrollee device 4B can, that enters a responder state, initiate an onboarding process by sending a bootstrapping information 512 over Li-Fi 450 as OOB to the configurator device 4A. The bootstrapping information 512 comprises DPP bootstrapping information, such as any of a bootstrapping public key associated with the enrollee device 4B (for example, embedded within a bootstrapping uniform resource indicator (URI)), a global operating class channel, a channel list for DPP authentication (DPP AUTH), or any combination thereof. For example, during the bootstrapping phase one or more DPP bootstrapping Li-Fi packets are communicated between the configurator device 4A and the enrollee device 4B, including, but not limited to, the bootstrapping information 512 over Li-Fi as OOB.

The configurator device 4A enters an initiator state after a successful bootstrapping phase and can respond to the bootstrapping information 512 received during the bootstrapping phase by initiating the authentication phase, for example, by sending an configuration instruction for DPP authentication 514A via a wireless network 550, such as by using Wi-Fi 470. The enrollee device 4B can in response to the configurator instruction 514A send an enrollee response for DPP authentication 514B via the wireless network 550.

The enrollee device 4B can initiate a provisioning phase after sending the enrollee response 514B by sending an enrollee request for provisioning (also referred to as configuring) 516A to the configurator device 4A via the wireless network 460. The configurator device 4A can in response to the enrollee request 516A can send configurator response for provisioning (also referred to as configuring) 516B via the wireless network 460.

After provisioning the enrollee device 4B, the enrollee device 4B can initiate a network access phase where the enrollee device 4B has full access to the Wi-Fi network 470 such that the enrollee device 4B and the configurator device 4A can exchange communications 518 via the Wi-Fi network 470.

FIG. 6 is a diagram of a message for a configurator device acting as an initiator to onboard an enrollee device acting as a responder, according to one or more aspects of the present disclosure. FIG. 6 is similar to or the same as FIG. 5 with additional details. A responder, in this example, enrollee device 4B, can advertise or send DPP bootstrapping information using Li-Fi. An initiator, in this example, configurator device 4A, can discover and obtain DPP bootstrapping information using Li-Fi. The responder enters bootstrapping mode and beings to advertise the DPP bootstrapping uniform resource indicator (URI) on an auxiliary channel.

The configurator device 4A and the enrollee device 4B can comprise Wi-Fi interfaces 602A and 602B, respectively, and Li-Fi interfaces 604A and 604B, respectively. As discussed with respect to FIG. 5, the enrollee device 4B can enter in a bootstrapping phase 603B and becomes a responder, such as enters a responder state 605. The enrollee device 4B can advertise or send DPP bootstrapping information as part of one or more DPP bootstrapping Li-Fi packets 606 via Li-Fi as OOB. The configurator device 4A receives the DPP bootstrapping information. The configurator device 4A will enter in bootstrapping phase 603A and listens for the advertisement via Li-Fi from the enrollee device 4B. For example, the configurator device 4A listens for the DPP bootstrapping information in one or more DPP bootstrapping Li-Fi packets 606. As an example, one or more client devices 4B-4E and/or client device 4G-4I within proximity of a client device 4A and/or client device 4F can send one or more advertisements, respectively, that indicate these client devices support bootstrapping over Li-Fi. Once the configurator device 4A receives the DPP bootstrapping information, the bootstrapping phase 603 (for example, 603A and 603B) is complete. Once the bootstrapping is complete, the configurator device 4A and becomes an initiator, such as enters an initiator state 607, and proceeds to complete onboarding of the enrollee device 4B. As discussed with reference to FIG. 5, the bootstrap phase progresses to the authentication phase 608, the provisioning phase 610, and the network access phase 612 with communications sent and received over a wireless network.

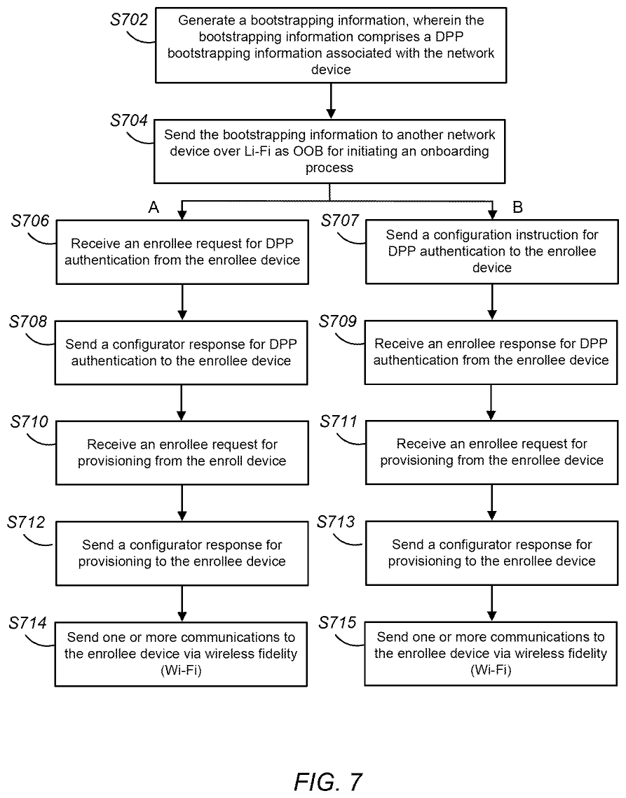

FIG. 7 is a flowchart illustrating a network device for using Li-Fi for initiating an onboarding process, according to one or more aspects of the present disclosure. In FIG. 7, it is assumed that any one or more network devices include their respective controllers and/or processors and their respective software (such as one or more computer-readable instructions) stored in their respective memories, as discussed above in reference to FIGS. 1-6, which when executed by their respective controllers perform one or more functions or operations in accordance with the example embodiments of the present disclosure.

The processor 210 executes one or more computer-readable instructions, stored in a memory, for example, a memory 220 of a network device 200, that when executed by the processor 210 perform and/or cause the network device 200 to perform one or more of the operations of steps S702-S714. In one or more embodiments, the one or more computer-readable instructions may be one or more software applications. While the steps S702-S714 are presented in a certain order, the present disclosure contemplates that any one or more steps can be performed simultaneously, substantially simultaneously, repeatedly, in any order or not at all (omitted).

At step S702, the network device for initiating an onboarding process over Li-Fi generates a bootstrapping information. The bootstrapping information comprises a DPP bootstrapping information associated with the network device. In one or more embodiments, DPP bootstrapping information comprises any of a bootstrapping public key, a channel indicator, and a channel list associated with the network device, or any combination thereof. In one or more embodiments, the bootstrapping public key is embedded within a bootstrapping uniform resource indicator

At step S704, the network device sends the bootstrapping information to another network device over Li-Fi as OOB for initiating an onboarding process. In one or more embodiments, the network device is a configurator device and the another network device is an enrollee device. In another one or more embodiments, the network device is an enrollee device and the another network device is configurator device.

After step S704 the process can continue at side A with steps S706 through S714 where the network device is a configurator device that enters a responder state and the another network device is an enrollee device that enters initiator state or at side B with steps S707-S715 where the network device is a configurator device that enters an initiator state and the another network device is an enrollee device that enters a responder state.

Beginning with side A, at step S706, the network device receives an enrollee request for DPP authentication from the enrollee device as discussed with reference to 414A of FIG. 4. At step S708, the network device sends a configurator response for DPP authentication to the enrollee device as discussed with reference to 414B of FIG. 4. At step 710, the network device receives an enrollee request for provisioning from the enrollee device as discussed with reference to 416A of FIG. 4. At step 712, the network device sends a configurator response for provisioning to the enrollee device. At step 714, the network device sends one or more communications to the enrollee device via Wi-Fi as discussed with reference to 418 of FIG. 4.

Turning to side B, at step S707 the network device sends a configuration instruction for DPP authentication to the enrollee device as discussed with reference to 514A of FIG. 5. At step S709, the network device receives an enrollee response for DPP authentication from the enrollee device as discussed with reference to 514B of FIG. 5. At step S711, the network device receives an enrollee request for provisioning from the enrollee device as discussed with reference to 516A of FIG. 5. At step S713, the network device sends a configurator response for provisioning to the enrollee device as discussed with reference to 516B of FIG. 5. At step S715, the network device sends one or more communications to the enrollee device via Wi-Fi as discussed with reference to 518 of FIG. 5.

In this way, a network device can be onboarded by initially using Li-Fi without user intervention.

The subject matter of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication or access network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

We claim:

1. A network device for initiating an onboarding process over Light Fidelity (Li-Fi) comprising:
a memory storing one or more computer-readable instructions; and
a processor configured to execute the one or more computer-readable instructions to cause the network device to:
generate a bootstrapping information, wherein the bootstrapping information comprises a device provisioning protocol (DPP) bootstrapping information associated with the network device; and
send the bootstrapping information to another network device over Li-Fi as out-of-band (OOB) for initiating an onboarding process.

2. The network device of claim 1, wherein the DPP bootstrapping information comprises any of a bootstrapping public key, a channel indicator, and a channel list associated with the network device, or any combination thereof.

3. The network device of claim 2, wherein the bootstrapping public key is embedded within a bootstrapping uniform resource indicator.

4. The network device of claim 2, wherein the network device is a configurator device that enters a responder state and the another network device is an enrollee device that enters an initiator state, and wherein the bootstrapping public key is associated with the configurator device.

5. The network device of claim 4, wherein the process is further configured to execute the one or more computer-readable instructions to further cause the network device to:
receive an enrollee request for DPP authentication from the enrollee device;
send a configurator response for DPP authentication to the enrollee device;
receive an enrollee request for provisioning from the enrollee device;
send a configurator response for provisioning to the enrollee device; and
send one or more communications to the enrollee device via wireless fidelity (Wi-Fi).

6. The network device of claim 2, wherein the network device is a configuration device that enters an initiator state and the another network device is an enrollee device that enters a responder state, and wherein the bootstrapping public key is associated with the enrollee device.

7. The network device of claim 6, wherein the process is further configured to execute the one or more computer-readable instructions to further cause the network device to:
send a configuration instruction for DPP authentication to the enrollee device;
receive an enrollee response for DPP authentication from the enrollee device;
receive an enrollee request for provisioning from the enrollee device;
send a configurator response for provisioning to the enrollee device; and
send one or more communications to the enrollee device via wireless fidelity (Wi-Fi).

8. A method for initiating an onboarding process over Light Fidelity (Li-Fi) by a network device, the method comprising:
generating a bootstrapping information, wherein the bootstrapping information comprises a device provisioning protocol (DPP) bootstrapping information associated with the network device; and
sending the bootstrapping information to another network device over Li-Fi as out-of-band (OOB) for initiating an onboarding process.

9. The method of claim 8, wherein the DPP bootstrapping information comprises any of a bootstrapping public key, a channel indicator, and a channel list associated with the network device, or any combination thereof.

10. The method of claim 9, wherein the bootstrapping public key is embedded within a bootstrapping uniform resource indicator.

11. The method of claim 9, wherein the network device is a configurator device that enters a responder state and the another network device is an enrollee device that enters an initiator state, and wherein the bootstrapping public key is associated with the configurator device.

12. The method of claim 11, further comprising:
receiving an enrollee request for DPP authentication from the enrollee device;
sending a configurator response for DPP authentication to the enrollee device;
receiving an enrollee request for provisioning from the enrollee device;
sending a configurator response for provisioning to the enrollee device; and
sending one or more communications to the enrollee device via wireless fidelity (Wi-Fi).

13. The method of claim 9, wherein the network device is a configurator device that enters an initiator state and the another network device is an enrollee device that enters a responder state, and wherein the bootstrapping public key is associated with the enrollee device.

14. The method of claim 13, further comprising:
send a configuration instruction for DPP authentication to the enrollee device;
receive an enrollee response for DPP authentication from the enrollee device;
receiving an enrollee request for provisioning from the enrollee device;
sending a configurator response for provisioning to the enrollee device; and
sending one or more communications to the enrollee device via wireless fidelity (Wi-Fi).

15. A non-transitory, computer-readable medium of a network device storing one or more computer-readable instructions for initiating an onboarding process over Light Fidelity (Li-Fi) that when executed by a processor, cause the device to perform one or more operations comprising:
generating a bootstrapping information, wherein the bootstrapping information comprises a device provisioning protocol (DPP) bootstrapping information associated with the network device; and
sending the bootstrapping information to another network device over Li-Fi as out-of-band (OOB) for initiating an onboarding process.

16. The non-transitory, computer-readable medium of claim 15, wherein the DPP bootstrapping information comprises any of a bootstrapping public key, a channel indicator, and a channel list associated with the network device, or any combination thereof, and wherein the bootstrapping public key is embedded within a bootstrapping uniform resource indicator (URI)), a global operating class channel, or a channel list for DPP authentication (DPP AUTH).

17. The non-transitory, computer-readable medium of claim 16, wherein the network device is a configurator device that enters a responder state and the another network device is an enrollee device that enters an initiator state, and wherein the bootstrapping public key is associated with the configurator device.

18. The non-transitory, computer-readable media of claim 17, wherein the one or more computer-readable instructions when executed by the processor, further cause the processor to perform the one or more operations further comprising:
receiving an enrollee request for DPP authentication from the enrollee device;
sending a configurator response for DPP authentication to the enrollee device;
receiving an enrollee request for provisioning from the enrollee device;
sending a configurator response for provisioning to the enrollee device; and
sending one or more communications to the enrollee device via wireless fidelity (Wi-Fi).

19. The non-transitory computer-readable media of claim 16, wherein the network device is a configurator device that enters an initiator state and the another network device is an enrollee device that enters a responder state, and wherein the bootstrapping public key is associated with the enrollee device.

20. The non-transitory computer-readable media of claim 19, wherein the one or more computer-readable instructions when executed by the processor, further cause the processor to perform the one or more operations further comprising:
send a configuration instruction for DPP authentication to the enrollee device;
receive an enrollee response for DPP authentication from the enrollee device;
receiving an enrollee request for provisioning from the enrollee device;
sending a configurator response for provisioning to the enrollee device; and
sending one or more communications to the enrollee device via wireless fidelity (Wi-Fi).
